(19) United States
(12) Patent Application Publication
(10) Pub. No.: US 2015/0053621 A1
(43) Pub. Date: Feb. 26, 2015

(54) METHOD FOR TREATING WATER AND FLOCCULANT FOR ORGANIC SUBSTANCES

(71) Applicant: Hitachi, Ltd., Tokyo (JP)

(72) Inventors: Kenji OKISHIRO, Tokyo (JP); Satoshi ISHII, Tokyo (JP); Hiroshi SASAKI, Tokyo (JP)

(73) Assignee: Hitachi, Ltd., Tokyo (JP)

(21) Appl. No.: 14/462,942

(22) Filed: Aug. 19, 2014

(30) Foreign Application Priority Data
Aug. 22, 2013 (JP) 2013-171880

(51) Int. Cl. C02F 1/56; B01J 20/26

(52) U.S. Cl. CPC C02F 1/56; B01J 20/265; C02F 2101/30
USPC 210/727; 252/180; 210/728

(57) ABSTRACT

Provided are a method for treating water and a flocculant used in the method. The method includes the steps of adding a first polymer compound formed by multiply binding a first repeating unit into water to be treated, and adding a second polymer compound formed by multiply binding a second repeating unit into the water. The first repeating unit includes a first linked main chain which constructs a main chain via repeatedly bound one another, and an adsorption site directly or indirectly bound to the first linked main chain so as to adsorb organic compounds contained in the water to be treated. The second repeating unit has a similar structure to the first repeating unit except that the number of carbon atoms in the second linked main chain is different from that in the first linked main chain. The flocculant includes the first and second polymer compounds.

### BACKGROUND OF THE INVENTION

1. Field of the Invention

The present invention relates to a method for treating water and a flocculant for agglomerating organic substances (or organic compounds).

2. Background Art

Recently, unconventional energy sources such as oil sand, shale gas, shale oil, and coal bed methane gas or the like are much attracted in North America and Australia etc. Here, deposit amounts of the unconventional gas and oil are estimated to have approximately the same as those of conventional ones. Accordingly, such huge estimated amounts may enhance expectation that the unconventional gas and oil are likely to be more practically utilized under the circumstance in which lack of global energy is concerned.

On the other hand, a large amount of water is used while extracting gas and oil from the underground of unconventional gas and oil fields. The large amount of water (or industrial water) thus used, causes a major problem against the protection of the environment.

For example, industrial water used for oil sand in Canada contains a large amount of organic compounds as impurities coexisting with the oil. Among these organic compounds, included is a substance like naphthanic acid which is concerned about the influence on ecosystems. Further, water discharged from a disused gas field (i.e., industrial water) may also contain a large amount of the organic compounds. Under the present circumstances, the industrial water is stored in a tailing pond, thereby to be disposed through natural evaporation.

However, the output of the industrial water tends to be increased associated with the increase in the oil extraction. Hereby, it becomes a big challenge to prevent tailing ponds from being more produced, and wild animals near the tailing ponds from being ecologically influenced. For example, efficient removal of organic compounds from water such as industrial water turns out an environmentally important challenge.

Here, a technique described in Japanese patent Application Publication No. 2012-45522 is a well-known method for removing organic compounds contained in water. That is, JP 2012-45522 discloses a sewage purification method by removing organic acids contained in the sewage. The method includes the steps of: separately adding a water soluble polymer including an acidic group, and a trivalent metal salt into the sewage; forming agglomerates containing organic acids; and removing the agglomerates so as to remove the organic acids contained in the sewage.

### SUMMARY OF THE INVENTION

According to JP 2012-45522, described is a technique which enhances a removal ratio of an organic acid such as naphthanic acid. Herein, it should be noted that naphthanic acid is an organic compound having a relatively small molecular size (e.g., the number of carbon atoms in the compound is from about 15 to 20), suggesting potential limitation of this technique.

In fact, investigation of the present inventors has revealed that the technique of the patent document has room for improving the removal ratio of an organic compound, when the technique is applied to the organic compound having a relatively large molecular size (e.g., the number of carbon atoms in the compound is from about 20 to 25).

From the viewpoint as mentioned above, the present invention has been developed so as to solve a drawback, that is, improvement of the removal ratio of organic compounds. Therefore, an object of the present invention is to provide a method for treating water capable of preferably removing target organic compounds, and a flocculant for agglomerating the organic compounds.

Accordingly, the present inventors have earnestly investigated a method for treating water to solve the above mentioned drawback, thereby to obtain the following findings. That is, a method for treating water of the present invention includes the steps of adding a first polymer compound formed by multiply binding a first repeating unit one another into water to be treated, and adding a second polymer compound formed by multiply binding a second repeating unit one another into the water.

More specifically, the first repeating unit includes a first linked main chain which constructs a main chain by multiply bound one another; and an adsorption site directly or indirectly bound to the first linked main chain so as to adsorb an organic compound contained in the water to be treated.

The second repeating unit includes a second linked main chain which constructs a main chain by multiply bound one another; and an adsorption site directly or indirectly bound to the second linked main chain so as to adsorb an organic compound contained in the water to be treated. Note the number of the carbon atoms in the second linked main chain is different from that in the first linked main chain.

Further, a flocculant for agglomerating organic compounds of the present invention includes a first polymer compound formed by multiply binding a first repeating unit one another and a second polymer compound formed by multiply binding a second repeating unit one another. More specifically, the first repeating unit includes a first linked main chain which constructs a main chain by multiply bound one another; and an adsorption site directly or indirectly bound to the first linked main chain so as to adsorb an organic compound contained in the water to be treated.

The second repeating unit includes a second linked main chain which constructs a main chain by multiply bound one another; and an adsorption site directly or indirectly bound to the second linked main chain so as to adsorb an organic compound contained in the water to be treated. Note the number of the carbon atoms in the second linked main chain is different from that in the first linked main chain.

According to the present invention, it is possible to provide a method for treating water capable of preferably removing organic compounds targeted to be removed, and a flocculant for agglomerating the organic compounds.

### BRIEF DESCRIPTION OF THE DRAWINGS

FIGS. 1A and 1B are diagrams showing a step of agglomerating organic compounds (or organic acids) conducted in a method for treating water in a present embodiment. FIG. 1A shows a state in which a flocculant of the present embodiment coexists with organic compounds. FIG. 1B shows a state in which the organic compounds are captured by the flocculant of the present embodiment.

FIG. 2 is a diagram showing simplified gas chromatograms of oil and gas industrial water.

FIG. 3 is a diagram showing a distance between adsorption sites in polyacrylic acid.

FIG. 4 is a diagram showing a distance between adsorption sites in the flocculant of the present embodiment.

FIG. 5 is a flowchart of the method for treating water in the present embodiment.

FIG. 6 is a flowchart of another method for treating water in the present embodiment.

### DETAILED DESCRIPTION OF THE INVENTION

Hereinafter, an embodiment for carrying out the present invention will be explained in detail referring to the attached drawings.

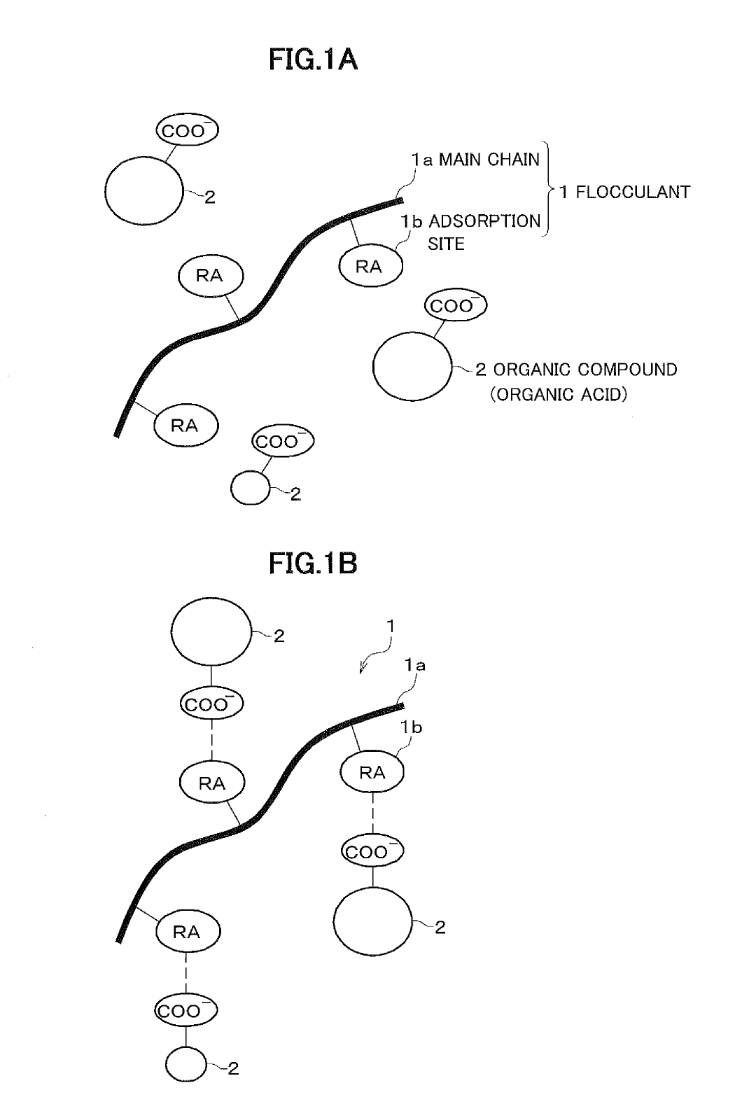

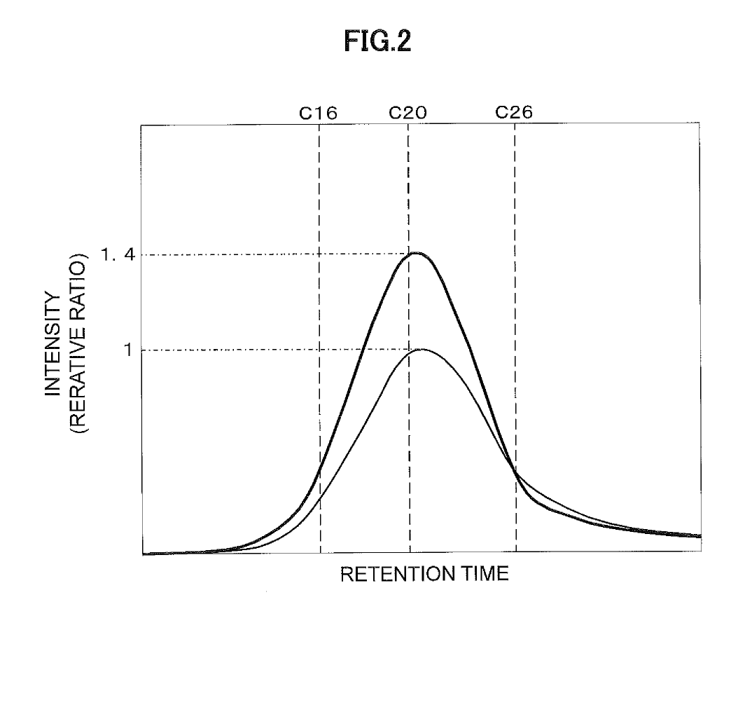

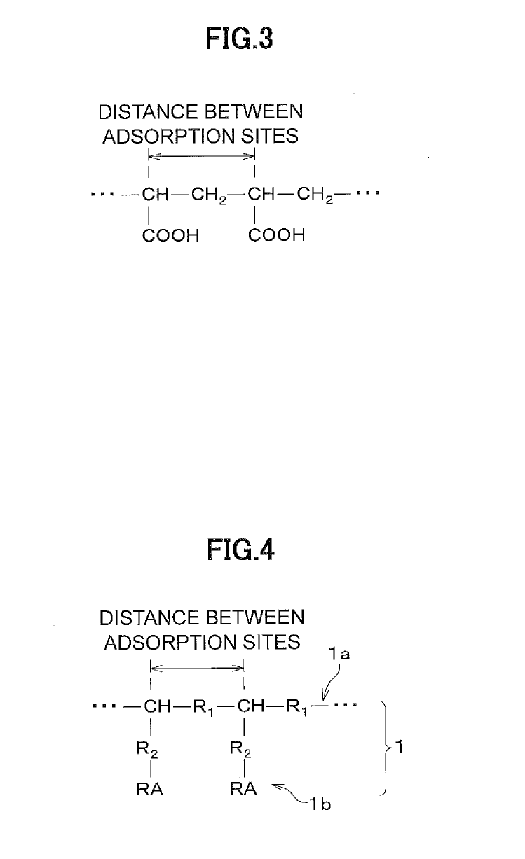

First, a method for treating water of the present embodiment will be conceptually described referring to FIGS. 1A, 1B and 2. Secondly, specific examples of the method for treating water of the present embodiment will be described referring to FIGS. 3-5.

The flocculant used in the method for treating water of the present embodiment is an agent of removing organic compounds. Herein, any organic compounds are acceptable to the method of the present embodiment, while the method is preferably used to remove organic acids. Note an “organic acid” described in the present embodiment means a compound having at least one acidic functional group such as a carboxyl group, an aromatic hydroxy group, and a sulfonic acid group in the molecule.

Hereby, the whole charge of the compound may be zero when the compound has one carboxyl group and one amino group simultaneously in the molecule. Even in such a case, the compound is also defined as an “organic acid”.

Further, in the following description, a method for removing organic compounds (e.g., organic acids) contained in industrial water discharged from an oil or gas field (hereinafter, simply referred to as “industrial water”) will be shown as an example. However, it should be noted that this is a mere example and does not limit the organic compound to only an organic compound contained in the industrial water.

Further, it should be noted that when industrial water is targeted, organic compounds having a wide range of molecular sizes are generally contained in the water. However, the method for treating water and the flocculant of the present embodiment may be applicable to the water even containing organic compounds having a relatively narrow range of molecular sizes. The details will be explained hereinafter.

FIGS. 1A and 1B are diagrams respectively showing a step of agglomerating organic compounds (or organic acids) in the method for treating water of the present embodiment. More specifically, FIG. 1A shows a state in which a flocculant of the present embodiment coexists with organic compounds. FIG. 1B shows a state in which the organic compounds are captured by the flocculant of the present embodiment.

Although the details will be explained hereinafter, the method for treating water of the present embodiment is performed by using a flocculant of the present embodiment, the flocculant agglomerating organic compounds. Hereinafter, the flocculant is simply referred to as the “flocculant” or the “flocculant 1”.

As shown in FIG. 1A, the flocculant 1 is formed including a linear main chain 1a, and an adsorption site 1b bound to the main chain 1a. Herein, the flocculant 1 is a polymer compound formed of a plurality of repeating units (that is, formed via repeatedly binding the unit one another). The details will be explained hereinafter.

The repeating unit includes a linked main chain (not shown in FIG. 1A) which constructs the main chain, and an adsorption site 1b. The adsorption site 1b is composed of a functional group (e.g., amino group) to which an organic compound (e.g., organic acid) is adsorbed. Note the flocculant 1 initially coexists with the organic compound 2 targeted to be agglomerated, just after addition of the flocculant 1 to the industrial water. Herein, the molecular weight of the organic compound 2 is relatively small, which makes it difficult to remove the organic compound 2 as it is from the industrial water.

In the state shown in FIG. 1A, when the industrial water is stirred to uniformly disperse the flocculant 1 in the entire water, the organic compound 2 is adsorbed by the adsorption site 1b shown in FIG. 1B. More specifically, as shown in FIG. 1A, an amino group in the adsorption site 1b of the flocculant 1 forms an ionic bond with a carboxyl group of the organic acid (or organic compound 2). At that time, iron chloride etc. may be added in the industrial water, where necessary. The ionic bond thus formed with the flocculant 1 no longer allows the organic compound 2 to be solved in the industrial water. This change in the property may cause agglomeration, whereby the organic compounds 2 precipitate with the flocculant 1. As a result, the organic compounds 2 may be removed from the industrial water.

FIG. 2 is a diagram showing simplified gas chromatograms of industrial water. In FIG. 2, the horizontal axis represents a retention time, and the vertical axis represents intensity of the chromatogram. The bold line and the thin line respectively represent chromatograms of two different types of industrial water actually collected at different places. The gas chromatograms shown in FIG. 2 are obtained by using an approximately non-polar column.

Therefore, the longer a retention time of the organic compound becomes, the larger a molecular size (or molecular weight) of the compound becomes. For example, when the gas chromatography is conducted via using a standard index carbon marker, a retention time of a molecule having 16 carbon atoms (i.e., C16) is about 16 to 17 min, and a retention time of a molecule having 20 carbon atoms (i.e., C20) is about 20 to 21 min.

Further, the higher intensity of the chromatogram in the virtual axis becomes, the larger a content of an organic compound in the industrial water becomes. For example, in FIG. 2, the maximum peak of the chromatogram shown in the bold line (e.g., C20 molecule) is about 1.4 fold higher than the maximum peak of the chromatogram shown in the thin line (e.g., C20 molecule).

This data indicates that the content of the organic compounds having about 20 carbon atoms (i.e., C20) in the industrial water shown by the bold line is about 1.4 fold higher than the content of the organic compounds having about 20 carbon atoms (i.e., C20) in the different industrial water shown by the thin line.

As shown in FIG. 2, although there is a difference in the intensity (i.e., difference in the contents of the organic compounds) between the two chromatograms shown by the bold and thin lines, the main peaks of both chromatograms are detected over the range from about C16 to C26 boundary. This data demonstrates that both kinds of the industrial water contain a large amount of the organic compounds having different molecular sizes. Herein, a characteristic feature of the industrial water is elucidated so that the molecular sizes of the organic compounds contained in the industrial water are larger than those of the organic compounds targeted in the different water treatment (e.g., sewage treatment).

In other words, organic compounds targeted in the conventional water treatment are mainly the compounds having molecular sizes of C10 or less. In contrast, as shown in FIG. 2, the industrial water contains organic compounds having molecular sizes in the range of about C16 to C26. Thus, those organic compounds in the industrial water have even larger molecular sizes than the organic compounds targeted in the conventional water treatment.

Conventionally, for example, in sewage treatment or the like, a polymer compound such as polyacrylic acid is utilized to remove organic compounds contained in the sewage. Here, polyacrylic acid is a polymer compound represented by the following formula (1).

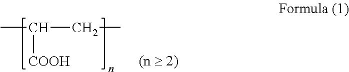

[where “n” in the formula (1) is an integer of 2 or more, and represents a polymerization degree.]

An organic compound in water is adsorbed to a carboxyl group (or carboxyl ion in water, similarly hereinafter) via such interaction as an ionic bond, a hydrogen bond, and van der Waals force. That is, the carboxyl group works as an adsorption site. Here, a “distance between the adsorption sites” is defined in the manner shown in FIG. 3. Namely, the “distance between the adsorption sites” is represented by the number of carbon-carbon bonds located between one carbon atom bound to one adsorption site (or carboxyl group in FIG. 3) in the main chain and the other carbon atom bound to the other adsorption site adjacent to said one adsorption site in the main chain.

Note if a ring system is included in the above mentioned structure, it may not be appropriate to represent the distance between the adsorption sites by the number of the carbon-carbon bonds in a strict meaning. However, even if a ring system is included, the distance between the adsorption sites may be represented the same as in the case of no ring system.

Specifically, in polyacrylic acid shown in FIG. 3, one carbon atom exists placed between one carbon atom bound to one carboxyl group in the main chain and the other carbon atom bound to the other carboxyl group located adjacent to said one carboxyl group in the main chain. Accordingly, the distance between the adsorption sites in the polyacrylic acid may be represented as a length of 2 carbon-carbon bonds. In this case, such a distance may be denoted as “the distance between the adsorption sites is represented as a 2 carbons length”, to express the distance in a simplifying manner. This denotation will be used similarly hereinafter.

Under the above denotation, the distance between the adsorption sites in polyacrylic acid is represented as a 2 carbons length. Here, it should be noted that the distance in case of polyacrylic acid is relatively short. Taking this character in consideration, the present inventors have investigated effects of polyacrylic acid on the removal of the organic compounds having larger molecular sizes contained in industrial water. The results thus obtained show the use of polyacrylic acid has drawbacks when applied to water treatment.

Firstly, decrease in the adsorption efficiency (or removal efficiency) occurs as a drawback. Namely, assume a case that an organic compound targeted to be adsorbed has a large molecular size compared to the distance between the adsorption sites in FIG. 3. Under this condition, if an organic compound is adsorbed to one adsorption site (i.e., carboxyl group in FIG. 3), this adsorption prevents in turn another organic compound from being adsorbed to an adsorption site adjacent to said one adsorption site because of the steric hindrance resulting from said adsorbed organic compound.

As a result, the utilization efficiency of the adsorption site is to be decreased, leading to decrease in the removal efficiency of the organic compounds.

Secondly, another drawback occurs in association with increase in the number of the adsorption sites which have lost the function of adsorbing organic compounds. That is, although steric hindrance prevents another organic compound from being adsorbed to an adsorption site adjacent to the adsorption site already adsorbing an organic compound, a water molecule having a small molecular size may be easily adsorbed to the adsorption site as long as the site adsorbs no compound, even though there is the steric hindrance.

Under this condition, when the flocculant is agglomerated and precipitates, many water molecules are adsorbed to the adsorption sites of the flocculant, which eventually increases the water content of the precipitate. Thus, the weight and volume of the agglomerate having the high water content get larger, thereby requiring a lot of labor in the treatment of the waste thus obtained. This results in the increase in the process costs.

When considering the above drawbacks, it is clear that the relationship between the molecular size of the organic compound targeted to be removed and the distance between the adsorption sites in the flocculant is a matter of great importance. Therefore, increase in the distant between the adsorption sites in the flocculant (i.e., increase in the carbon number at the related region of the main chain) may allow an organic compound having a larger molecular size than a conventionally treated compound to be efficiently adsorbed and agglomerated.

As a result, the increase in the distance may improve the removal efficiency of the organic compounds. Further, this may decrease the water content of the agglomerate.

Moreover, industrial water contains organic compounds having different molecular sizes as shown in FIG. 2. Therefore, the distribution of the molecule weights in the industrial water is wide. In this regard, it is clear that if 2 or more types of flocculants having different distances between the adsorption sites are utilized in the water treatment, the organic compounds having a wide distribution range of the molecular weights may be efficiently removed from the industrial water.

Accordingly, it is possible to efficiently remove the organic compounds in an even manner, in spite of any molecular size, from the industrial water containing organic compounds with a wide distribution range of the molecular weights.

From the viewpoint as described above, the flocculant of the present embodiment includes 2 types of polymer compounds having different distances between the adsorption sites (i.e., a first polymer compound and a second polymer compound). More specifically, the flocculant of the present embodiment includes a first polymer compound formed via binding a plurality of first repeating units, and a second polymer compound formed via binding a plurality of second repeating units.

The first repeating unit includes a first linked main chain which constructs a main chain via repeatedly bound one another; and an adsorption site directly or indirectly bound to the first linked main chain so as to adsorb organic compounds contained in the water to be treated. The second repeating unit includes a second linked main chain which constructs a main chain via repeatedly bound one another; and an adsorption site directly or indirectly bound to the second linked main chain so as to adsorb organic compounds contained in the water to be treated. Note the number of carbon atoms in the second linked main chain is different from that in the first linked main chain.

The structures of the first and second polymer compounds are not limited to specific ones as long as both polymer compounds have the above denoted structures. However, preferably, the structure of the first polymer compound is specifically represented by the following formula (2). Further, preferably, the structure of the second polymer compound is specifically represented by the following formula (3).

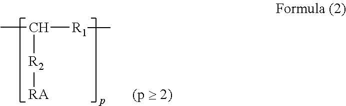

[where “p” is an integer of 2 or more, and represents a polymerization degree of the repeating unit as indicated in the square brackets (i.e., first repeating unit) in the formula (2)]

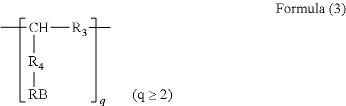

[where “q” is an integer of 2 or more, and represents a polymerization degree of the repeating unit as indicated in the square brackets (i.e., second repeating unit) in the formula (3)]

Here, R₁ and R₃ together form a linked main chain with the CH group bound to R₁ and R₃. If one absorption site is bound to one linked main chain, the number of carbon atoms constructing said “linked main chain” represents a distance between the adsorption sites. Note, for convenience, this kind of a linked main chain of the first polymer compound is referred to as a first linked main chain represented by the formula (2). In turn, this kind of a linked main chain of the second polymer compound is referred to as a second linked main chain represented by the formula (3).

Therefore, the number of the carbon atoms of the first linked main chain is calculated by adding 1 to the number of the carbon atoms of R₁ in the formula (2). Similarly, the number of the carbon atoms of the second linked main chain is calculated by adding 1 to the number of the carbon atoms of R₃ in the formula (3).

Here, the first linked main chain works as a linker for binding a repeating unit (i.e., first repeating unit) one another as represented by the formula (2), whereby the first polymer compound is constructed by those units. The second linked main chain works as a linker for binding a repeating unit (i.e., second repeating unit) one another as represented by the formula (3), whereby the second polymer compound is constructed by those units. As a result, the plurality of linked main chains repeatedly bound each other lead to construction of the main chain 1a shown in FIG. 1A.

Here, R₁ and R₃ include a carbon atom, and the number of the carbon atoms of the first linked main chain is different from that of the second main chain. Further, the distances between the adsorption sites of the first and second polymer compounds are defined as shown in FIG. 4. Herein, the drawing of the second polymer compound will be omitted since it is similar to FIG. 4. The definition of the distance in FIG. 4 is the same as that in FIG. 3 showing the distance between the adsorption sites in polyacrylic acid. Thus, when the number of the carbon atoms in R₁ is different from that in R₃, the distance between the adsorption sites in the first linked main chain is different from that in the second linked main chain.

From the viewpoint as mentioned above, the physical properties of the first and second polymer compounds are represented by the numbers of the carbon atoms in R₁ and R₃ respectively, highlighting the difference in the distances between the adsorption sites in the present embodiment.

Here, the numbers of the carbon atoms in R₁ and R₃ determining the distances between the adsorption sites are not limited to specific ones. However, the numbers are preferably in the range from 8 to 18. Note either of the numbers in R₁ and R₃ may be in the above mentioned range. The number of the carbon atoms in R₁ is different from that in R₃. The above mentioned character allows the organic compounds contained especially in the industrial water to be more preferably adsorbed and agglomerated.

Further, the more the numbers of the carbon atoms in R₁ and R₃ increase, the more the hydrophobicity of R₁ and R₃ increases, which is likely to result in decrease in the water solubility of the first and second polymer compounds. Therefore, from the viewpoint for increasing the water solubility of the first and second polymer compounds, R₁ and R₃ may preferably contain a hydrophilic group, more specifically, a hydrophilic oxygen atom. Note such a hydrophilic group may be included in only either of R₁ and R₃.

The hydrophilic oxygen atom may be, for example, an oxygen atom capable of forming a hydrogen bond with a water molecule, more specifically, an ether group, a hydroxy group, an ester group, and a carboxyl group or the like. Those functional groups may be contained in the first and second linked main chains respectively, or those groups may be bound to the main chains as the substituent groups.

Here, as mentioned above, the hydrophobicity of R₁ and R₃ is likely to increase as the numbers of the carbon atoms in R₁ and R₃ increase. Herein, it should be noted that if the number of hydrophobic parts inside a molecule increases, those hydrophobic parts inside the molecule attract each other, which is likely to make the molecular shape be spherical. Accordingly, R₁ and R₃ may preferably have a rigid structure so as to prevent the molecular shape form being spherical. Herein, note only either of R₁ and R₃ may have such a rigid structure. More specifically, R₁ and R₃ may preferably include an unsaturated bond such as a double bond and a triple bond for having the rigid structure.

The above mentioned structure may prevent the carbon-carbon bond at the unsaturated bond part from rotating, thereby to prevent the molecule shape from changing into a spherical one.

Further, R₁ and R₃ may preferably include a ring system respectively. Note only either of R₁ and R₃ may include such a ring system. The ring system includes, for example, an aromatic ring such as a benzene ring, and an aliphatic ring such as a cyclohexane ring. The ring system thus incorporated may provide a steric hindrance with the first and second linked main chains, thereby preventing each shape of the entire chains from changing to be spherical. This may allow the adsorption sites to have more open space, thereby facilitating the adsorption sites bound to the main chains to adsorb the organic compounds.

Next, RA and RB are absorption sites to which organic compounds contained in the water are adsorbed. RA and RB representing adsorption sites may be appropriately selected depending on the types of organic compounds targeted to be removed. Herein, RA and RB are not particularly limited to specific ones. However, it should be noted that RA and RB are preferably groups each of which forms an ionic bond and a hydrogen bond with the organic compound targeted to be removed. More specifically, preferably each of RA and RB may be independently at least one functional group selected from a carboxyl group, a sulfonic acid group, an amino group, and a hydroxy group.

For example, a sulfonic acid group is preferable to adsorb an organic compound with strong alkaline property, since almost sulfonic acid groups are ionized in water to be the form of —SO₃⁻ therein. On the other hand, an amino group is preferable to adsorb an acidic organic compound, since an amino group is ionized in water to be the form of —NH₃⁺ therein.

Next, R₂ is a linker for binding RA to the first linked main chain. R₄ is a linker for binding RB to the second linked main chain. Herein, when there are R₂ and R₄, RA is indirectly bound to the first linked main chain, and RB is indirectly bound to the second linked main chain.

Alternatively, if there are no R₁ and R₄, RA is directly bound to the first linked main chain, and RB is directly bound to the second linked main chain.

Here, from the viewpoint for easily controlling the properties of the first and second polymer compounds, the first and second polymer compounds may preferably have the same structure except that there is a deference only in the numbers of the carbon atoms between R₁ and R₃. More specifically, for example, preferably R₂ is identical to R₄, RA is identical to RB, and a value of “p” is identical to a value of “q”.

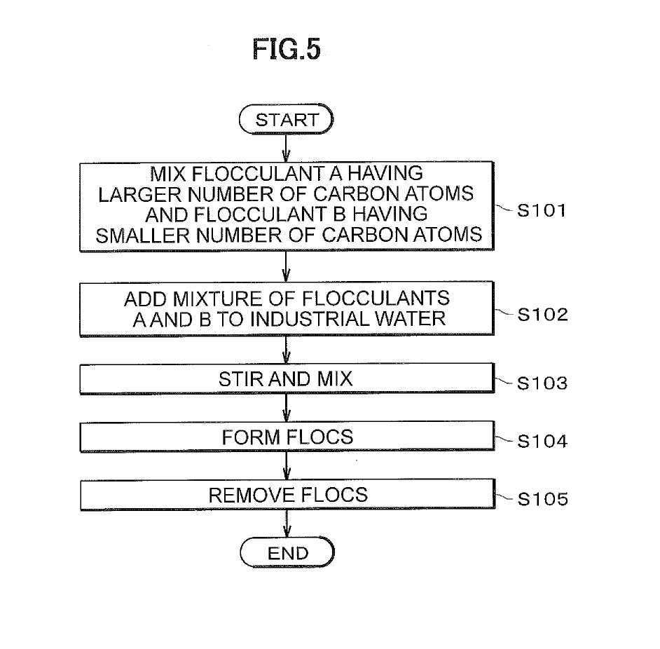

Next, FIG. 5 is a flowchart showing a method for treating water in the present embodiment. Referring to FIG. 5, a method for treating water via using the flocculant will be described in detail. In FIG. 5, an organic acid contained in the industrial water is exemplified as an organic compound targeted to be removed from the water (also referring to FIG. 2). However, the water is not limited to the industrial water. Further, flocculant A and flocculant B respectively correspond to the first polymer compound and the second polymer compound in FIG. 5.

Herein, flocculant A has a linked main chain with the larger number of the carbon atoms in the polymer compound, while flocculant B has a linked main chain with the smaller number of the carbon atoms in the polymer compound.

First, the flocculant A having the larger number of the carbon atoms and the flocculant B having the smaller number of the carbon atoms are mixed together (step S101). Then, the mixture of the flocculants A and B is added to the industrial water (step S102). Quickly after the addition, the industrial water is sufficiently stirred to diffuse the mixture of the flocculants in the whole industrial water (step S103).

Accordingly, organic acids contained in the industrial water are adsorbed to the flocculant A or the flocculant B corresponding to the respective molecular sizes of the organic acids, thereby to cause agglomeration of the organic acids with the flocculants A and B, resulting in the formation of flocs (step S104). Finally, the flocs thus formed are removed by filtration or the like (step S105), whereby removal of all the organic acids contained in the industrial water is accomplished.

As mentioned hereinbefore, the steps of mixing beforehand the flocculants A and B having the different numbers of the carbon atoms each other, and adding the mixture into the industrial water (i.e., the addition of the flocculant A is simultaneously conducted with the addition of the flocculant B) allow the removal process of the organic compounds to be simpler.

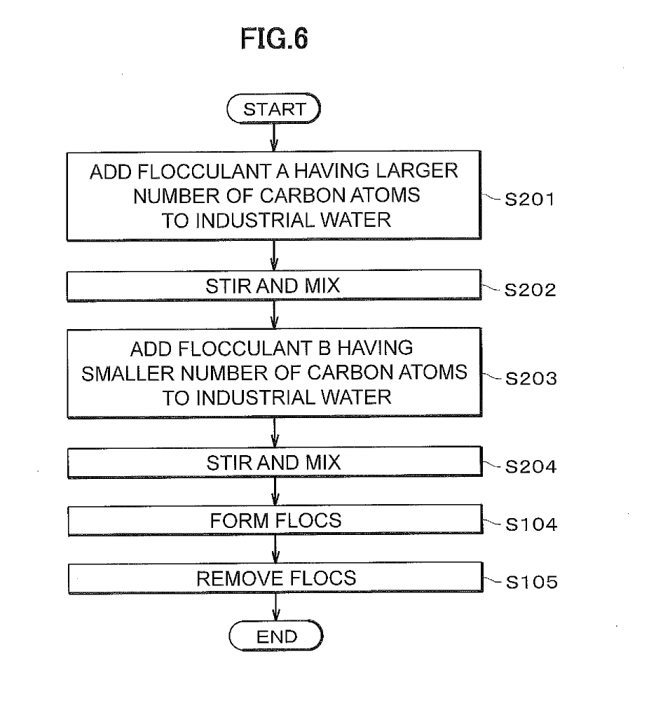

Alternatively, the addition of the flocculant A may be conducted separately from the addition of the flocculant B (i.e., the 2 additions are conducted at the different timing). This process allows the efficiency in removal of the organic compounds to be improved. Next, that process will be described in detail referring to FIG. 6.

FIG. 6 is a flowchart showing another method for treating water in the present embodiment. First, the flocculant A having the larger number of the carbon atoms is added to the industrial water (step S201). Then, the industrial water is sufficiently stirred and mixed (step S202). Those steps allow the flocculant A to diffuse in the whole industrial water. Next, the flocculant B having the smaller number of the carbon atoms is added to the industrial water (step S 203). This allows the flocculant B to diffuse in the whole industrial water. After that, flocs are formed as in the flowchart of FIG. 5 (step S104), and then the flocs are removed (step S105), whereby removal of all the organic acids contained in the industrial water is accomplished.

In the flowchart of FIG. 6, the flocculant A having the larger number of the carbon atoms is firstly added to the industrial water. Here, when the structure of the flocculant A is compared to the structure of the flocculant B, provided that both structures are the same except that there is a difference in the number of the carbon atoms of the respective linked main chain, the molecular size of the flocculant A is larger than the molecular size of the flocculant B. Note a flocculant having a larger molecular size has higher hydrophobicity. Accordingly, addition of the flocculant A having the larger molecular size at the first timing allows organic compounds having larger molecular sizes to be sufficiently agglomerated.

As a result, when the flocculant B is added in turn to the industrial water, the content of the organic compounds having the larger number of the carbon atoms contained in the industrial water is decreased. This facilitates the utilization efficiency of the adsorption sites in the flocculant B to be significantly improved. Therefore, from the viewpoint of more improving the removal ratio of the organic compounds, it is preferable to firstly add the flocculant A having the larger number of the carbon atoms, and subsequently add the flocculant B having the smaller number of the carbon atoms at the different timing.

Alternatively, from the viewpoint of easiness in removing the flocs to be formed, it is preferable to firstly add the flocculant B having the smaller number of the carbon atoms to the industrial water, and subsequently add the flocculant A having the larger number of the carbon atoms.

Specifically, by firstly adding the flocculant B having the smaller number of the carbon atoms to the industrial water, microflocs including organic compounds having the smaller molecular sizes are formed in the water. Then, by subsequently adding the flocculant A having the larger number of the carbon atoms to the water, organic compounds having the larger molecular sizes are agglomerated with the microflocs, whereby large flocs are formed. The formation of the large flocs allows the flocs to be removed by using a coarse filter, giving such an advantage that the flocs thus formed are more easily removed.

As described hereinbefore, the order and timing of adding the flocculant A and the flocculant B to the industrial water may be appropriately determined depending on the removal efficiency and costs in the process.

Regarding the flocculant, it is not always needed to add only 2 types of the flocculants A and B to the industrial water. Therefore, another flocculant having the different number of the carbon atoms in the linked main chain may be further added to the water.

### EXAMPLE

Hereinafter, the present embodiment will be more specifically described in detail referring to the following Examples.

(Preparation of Simulation Water)

Simulation water of the industrial water was prepared so as to evaluate the method for treating water of the present embodiment via applying the method to the industrial water of FIG. 2. Specifically, the simulation water was prepared by mixing hexadecanoic acid (C₁₆H₃₂O₂), octadecanoic acid (C₁₈H₃₆O₂), naphthanic acid (e.g., including at least a carboxylic acid having the number of carbon atoms from about 20 to 26) or the like with water.

Further, in order to make the components of the simulation water closely similar to the components of the actual industrial water, inorganic ions such as sodium, potassium, magnesium, and calcium ions were also added to the water. To adjust the respective contents, the concentration of the sodium ion was set at 200 ppm, and the concentration of other inorganic ion was set at 20 ppm.

A COD (Chemical Oxygen Demand) value of the simulation water was 200 mg/L. The COD value was measured by the method using potassium dichromate, the method being widely used in Europe and America. Here, the smaller a COD value is, the smaller an amount of organic compounds contained in the water is.

### Example 1

In Example 1, following the flowchart of FIG. 5, the flocculant A and the flocculant B were mixed and added to the water, whereby the method for treating water was evaluated. As the flocculant A in FIG. 5, used was a flocculant in which the number of the carbon atoms in the linked main chain was 17 (i.e., the distance of the adsorption sites was represented as C17), and the number of the carbon atoms in R₁ was 16 in Formula (2). Further, as the flocculant B, used was a flocculant in which the number of the carbon atoms in the linked main chain was 11 (i.e., the distance of the adsorption

Herein, the structure of the flocculant A was almost the same as the structure of the flocculant B except for the difference in the number of the carbon atoms as mentioned above.

First, the simulation water thus prepared was added to an flocculation tank. Then, while stirring the water at a constant rate, the mixture of the flocculants A and B was added to the water and stirred. The flocs thus formed were removed. After removing the flocs, COD of the water (or treated water) was measured, giving a COD value of 40 mg/L.

As mentioned above, when the mixture of the flocculants A and B was added to the simulation water, the content of the organic compounds was decreased up to one-fifth of the initial one. Accordingly, it was shown that the organic compounds contained in the water were sufficiently removed by using 2 types of flocculants different in the number of the carbon atoms in the linked main chain.

### Example 2

Following the flowchart of FIG. 6, the method for treating water was evaluated in the same manner as in Example 1, except that the flocculant A and the flocculant B were added to the simulation water in a stepwise manner. As a result, the COD value of the treated water was 30 mg/L after the treatment of the water.

In Example 2, as different from Example 1, the flocculant A and the flocculant B were added to the simulation water at the separated timing. Under such conditions, the organic compounds contained in the water were further sufficiently removed from the water. In particular, the COD value after the treatment of the water was lower than that in Example 1. This demonstrated that the steps of separately mixing the flocculant A and the flocculant B at the different timing enabled the organic compounds to be more sufficiently removed from the water.

### Comparative Example

A COD value of the treated water was measured in the same manner as in Example 1 except that the flocculants A and B were not used but polyacrylic acid in formula (1) was used in Comparative Example. As a result, the COD value was 100 mg/L. Accordingly, when conventionally used polyacrylic acid was applied to the method for treating water, only a half amount of the organic compounds contained in the water was removed. This result demonstrated that if organic compounds contained in the water had various molecular sizes, it was impossible to sufficiently remove the organic compounds by polyacrylic acid used as a conventional flocculant.

(Summary)

The results in the above evaluation demonstrate that the method for treating water of the present embodiment enables a 2.5 to 3-fold larger amount of organic compounds to be removed than a conventional method for treating water (see Comparative Example) even when the water contains organic compounds with various molecular sizes. In other words, according to the present invention, it is demonstrated that organic compounds targeted to be removed are preferably removed by the method for treating water of the present embodiment.

What is claimed is:

1. A method for treating water comprising the steps of:
adding a first polymer compound formed by multiply binding a first repeating unit into water to be treated, and
adding a second polymer compound formed by multiply binding a second repeating unit into the water to be treated, wherein
the first repeating unit comprised of a first linked main chain which constructs a main chain via repeatedly bound one another, and an adsorption site directly or indirectly bound to the first linked main chain so as to adsorb organic compounds contained in the water to be treated, and
the second repeating unit comprised of a second linked main chain which constructs a main chain via repeatedly bound one another, and an adsorption site directly or indirectly bound to the second linked main chain so as to adsorb organic compounds contained in the water to be treated, wherein
the number of carbon atoms in the second linked main chain is different from the number of carbon atoms in the first linked main chain.

2. The method for treating water according to claim 1, wherein at least either of the adsorption site in the first polymer compound or the adsorption site in the second polymer compound is composed of a functional group selected from a carboxyl group, a sulfonic acid group, an amino group and a hydroxy group.

3. The method for treating water according to claim 1, wherein at least either of the number of carbon atoms in the first linked main chain or the number of carbon atoms in the second linked main chain is in the range from 8 to 18.

4. The method for treating water according to claim 1, wherein at least either of the first linked main chain or the second linked main chain includes a ring system.

5. The method for treating water according to claim 1, wherein at least either of the first linked main chain or the second linked main chain includes an unsaturated bond.

6. The method for treating water according to claim 1, wherein at least either of the first linked main chain or the second linked main chain includes a hydrophilic oxygen atom.

7. The method for treating water according to claim 1, wherein the steps of adding the first polymer compound and adding the second polymer compound are simultaneously conducted.

8. The method for treating water according to claim 1, wherein the steps of adding the first polymer compound and adding the second polymer compound are stepwise conducted at separated timing.

9. The method for treating water according to claim 8, wherein the method is conducted firstly by adding a polymer compound having the larger number of the carbon atoms to the water to be treated, and secondly by adding the remaining polymer compound, based on comparison between the number of the carbon atoms in the first linked main chain and the number of the carbon atoms in the second linked main chain, respectively included in the first and second polymer compounds.

10. A flocculant for agglomerating organic compounds, comprising:
a first polymer compound formed by multiply binding a first repeating unit, and a second polymer compound formed by multiply binding a second repeating unit,
the first repeating unit comprising:
a first linked main chain which constructs a main chain via repeatedly bound one another, and
an adsorption site directly or indirectly bound to the first linked main chain so as to adsorb organic compounds contained in water to be treated, and
the second repeating unit comprising:
a second linked main chain which constructs a main chain via repeatedly bound one another, and
an adsorption site directly or indirectly bound to the second linked main chain so as to adsorb organic compounds contained in the water to be treated, wherein
the number of carbon atoms in the second linked main chain is different from the number of carbon atoms in the first linked main chain.

11. The flocculant according to claim 10, wherein at least either of the adsorption site in the first polymer compound or the adsorption site in the second polymer compound is composed of a functional group selected from a carboxyl group, a sulfonic acid group, an amino group and a hydroxy group.

12. The flocculant according to claim 10, wherein at least either of the number of carbon atoms in the first linked main chain or the number of carbon atoms in the second linked main chain is in the range from 8 to 18.

13. The flocculant according to claim 10, wherein at least either of the first linked main chain or the second linked main chain includes a ring system.

14. The flocculant according to claim 10, wherein at least either of the first linked main chain or the second linked main chain includes an unsaturated bond.

15. The flocculant according to claim 10, wherein at least either of the first linked main chain or the second linked main chain includes a hydrophilic oxygen atom.
